(19) United States
(12) Patent Application Publication
(10) Pub. No.: US 2003/0085620 A1
(43) Pub. Date: May 8, 2003

(54) Antitheft system, method for operating an antitheft system and components of an antitheft system

(76) Inventor: Heinz Herbrik, Obertraubling (DE)

Correspondence Address: Bruce W. Slayden II, Baker Botts L.L.P., 910 Louisiana, Houston, TX, 77002-4995, US

(21) Appl. No.: 10/264,624

(22) Filed: Oct. 4, 2002

(30) Foreign Application Priority Data
Oct. 5, 2001 (DE) 101 49 276.6

(51) Int. Cl. B60R 25/00

(52) U.S. Cl. 307/10.2

(57) ABSTRACT

An antitheft system for a vehicle has at least one radio frequency receiver unit (10) which is connected to the vehicle and has at least one first antenna (12), at least one code transmitter (14) with at least one radio frequency transmitter unit which has at least one second antenna (16), and means for evaluating signals which are received by the at least one receiver unit (10). The first antenna (12) or the second antenna (16) is a directional antenna.

### BACKGROUND OF THE INVENTION

The invention relates to an antitheft system for a vehicle having at least one radio frequency receiver unit which is connected to the vehicle and has at least one first antenna, at least one code transmitter having at least one radio frequency transmitter unit which has at least one second antenna, and means for evaluating signals which are received by the at least one receiver unit.

The invention also relates to a method for operating an antitheft system for a vehicle in which at least one radio frequency receiver unit which is connected to the vehicle receives radio frequency signals via a first antenna, at least one code transmitter with at least one radio frequency transmitter unit transmits radio frequency signals via at least one second antenna, and the at least one receiver unit evaluates received signals.

In addition, the invention relates to components of an antitheft system.

Systems, methods and components of the generic type (DE 199 57 536 A1) are frequently used as a replacement for the mechanical locking systems which are conventionally present in motor vehicles. The systems operate on the basis of a code which is transmitted by a code transmitter to a receiver unit in a motor vehicle. The signals which are transmitted by the code transmitter and received by a receiver unit are evaluated by an evaluation unit in the vehicle so that, when the code is acceptable, the vehicle can be opened or, when an immobilizer is also present, the vehicle can be used. Different methods of transmission of coded signals between the code transmitter and the receiver unit arranged in the vehicle are known. The present invention relates to communication by means of radio frequency signals. It is also known to use low frequency signals or infrared signals for contactless transmission.

In radio frequency systems it is known, for example, to use frequencies in the range between 433 MHz and 868 MHz.

For safety reasons, it is necessary to avoid unintentional opening or closing of a vehicle. For this reason, it is customary in radio frequency systems to limit the transmitter power so that there is, for example, a maximum range of 6 m. Although this increases security in terms of unintentional activation from a considerable distance, it is however still possible for a motor vehicle to be opened or closed without a line-of-sight connection between the code transmitter and motor vehicle, which can ultimately lead to unintentional activation of the vehicle lock system.

### SUMMARY OF THE INVENTION

The invention is based on the object of making available an antitheft system, a method for operating an antitheft system and components of an antitheft system, the disadvantages of the prior art being eliminated, and in particular unintentional opening or closing of the vehicle being avoided in all cases.

This object is achieved by an antitheft system for a vehicle having

at least one radio frequency receiver unit which is connected to the vehicle and has at least one first antenna,

at least one code transmitter having at least one radio frequency transmitter unit which has at least one second antenna, and

means for evaluating signals which are received by the at least one receiver unit, wherein at least the first antenna or the second antenna is a directional antenna.

Furthermore the object can be achieved by a method for operating an antitheft system for a vehicle, in which

at least one radio frequency receiver unit which is connected to the vehicle receives radio frequency signals via a first antenna,

at least one code transmitter having at least one radio frequency transmitter unit transmits radio frequency signals via at least one second antenna, and

the at least one receiver unit evaluates received signals, wherein at least the first antenna or the second antenna is a directional antenna.

Advantageous embodiments of the invention are given in the dependent claims.

The invention is based on the antitheft system of the generic type in that at least the first antenna or the second antenna is a directional antenna. This ensures that the antitheft system can be activated only when there is a line-of-sight connection between the code transmitter and the vehicle. Unintentional activation of the lock system is thus avoided.

The antitheft system according to the invention is advantageously developed in that the radio frequency receiver unit which is connected to the vehicle is contained in a transceiver unit, the first antenna operating as a transmission antenna and reception antenna, and in that the radio frequency transmitter unit which is provided in the code transmitter is contained in a transceiver unit, the second antenna operating as a transmission antenna and reception antenna. In this way, the respective transmitter units and receiver units can communicate with one another via antennas. As a result, different technologies can be used for the transmission of coded signals from the code transmitter to the transceiver unit of the vehicle.

It is advantageously possible to provide that the second antenna which is assigned to the code transmitter is provided for receiving signals which are transmitted by the transceiver unit of the vehicle, in that the code transmitter has means for modulating the received signals, and in that the second antenna which is assigned to the code transmitter is provided for transmitting the modulated signals. When the antitheft system according to the invention is configured in such a way, there is provision for the primary signal—received by the code transmitter—of the transceiver unit which is connected to the vehicle to be modulated in the code transmitter. This modulation can be carried out, for example, with a code which can be set differently from lock system to lock system or from key to key. The modulated signals which are transmitted back to the transceiver unit of the vehicle by the code transmitter can then be evaluated in the motor vehicle. Such a system, in which the code transmitter operates as an active reflector, is also referred to as a back scatter system. In conjunction with the inventive directional effect of one or more antennas, a reliable and safe system is made available which also has the advantage that the code transmitter can be configured to be more energy-saving than when primary signals have to be broadcast by the code transmitter. In addition to the active back scatter system, it is also possible to use a passive back scatter, the reflection behavior of the antenna being changed by switching over the antenna adaptation. This is also a way of impressing a code on the reflected signal.

Furthermore, it may be particularly advantageous for the range of the radio frequency signals to be limited. Range limitation of the radio frequency signals is already known from the prior art. In combination with directional radio frequency communication it is possible to make available a particularly safe system.

The system according to the invention is particularly advantageously developed in that the evaluation means determine a variable as a measure of the distance between the vehicle and the code transmitter. This also makes it possible to ensure that the locking function is activated only starting from a certain maximum distance between the code transmitter and vehicle. The distance measurement can be carried out in addition to a range limitation of the radio frequency signals. It is also possible to determine distances as an alternative to limiting the range.

In one particularly preferred embodiment of the present invention there is provision for the evaluation means to determine a variable as a measure of the distance between the vehicle and the code transmitter by means of back scatter radar technology. Distances can be determined by means of back scatter radar technology in that, for example, the broadcasting frequency of the transceiver unit arranged in the vehicle is varied over time. The received frequency is then differentiated from the emitted frequency on the basis of the transit time of the signals between the vehicle and code transmitter. The frequency shift is then a measure of the distance between the vehicle and code transmitter. For example, the frequency difference can be determined by means of the magnitude of the mixed frequency of the broadcast frequency and received frequency. Such a method is also referred to as the frequency-modulated continuous-wave radar method (FMCW radar method).

The antitheft system according to the invention is particularly advantageously developed in that the system operates in the GHz range. In the GHz range, antennas with a directional effect can be implemented in a particularly easy way, for example in the form of horn antennas or Yagi antennas. In comparison with radio frequency systems of the prior art, a system which operates, for example, at 24 GHz can therefore be implemented particularly reliably as a system which operates with directional signals.

The invention is based on the method of the generic type in that at least the first antenna or the second antenna is a directional antenna. In this way, the advantages of the antitheft system according to the invention are also implemented within the scope of a method. This also applies to the preferred embodiments of the method according to the invention which are described below.

It is particularly preferable for the first antenna to be used as a transmission antenna and reception antenna of a transceiver unit which is connected to the vehicle, and for the second antenna to be used as a transmission antenna and reception antenna of a transceiver unit which is provided in the code transmitter.

On the basis of this embodiment it is particularly advantageous to develop the method according to the invention in such a way that the first antenna which is assigned to the vehicle transmits radio frequency signals, that the second antenna which is assigned to the code transmitter receives the signals which are transmitted by the first antenna, that the signals which are received by the second antenna are modulated in the code transmitter, that the second antenna transmits the modulated signals, that the first antenna receives the transmitted modulated signals, and that the modulated signals received by the first antenna are evaluated.

In combination with the method according to the invention it is particularly useful for the range of the radio frequency signals to be limited.

In one particularly preferred embodiment of the method according to the invention there is provision that, during the evaluation of the signals received by the receiver unit of the vehicle, a variable is determined as a measure of the distance between the vehicle and the code transmitter.

It is particularly useful that, during the evaluation of the signals received by the receiver unit of the vehicle, a variable is determined as a measure of the distance between the vehicle and the code transmitter by means of back scatter radar technology.

The method according to the invention can be used particularly reliably if the system operates in the GHz range.

The invention also relates to a radio frequency receiver unit which is connected to a vehicle and can be used in an antitheft system according to the invention.

The invention is particularly advantageously developed in that the radio frequency receiver unit is contained in a transceiver unit.

In addition, the invention relates to a code transmitter which can be used in a system according to the invention.

The invention is based on the realization that an antitheft system can operate particularly reliably in the radio frequency range by using directional antennas. If, for example, higher and higher frequencies are used, for example in the range of 24 GHz, the behavior of the radio frequency radiation increasingly resembles the propagation of light. It is therefore possible to impress a specific propagation direction on the radio frequency radiation so that the locking device or the antitheft system can be activated only when there is a line-of-sight connection between the code transmitter and vehicle. Such a directional high frequency system can advantageously be combined with a distance limiting means, or a distance measuring means, so that as a result additional security is provided in terms of unintentional activation of the system.

### BRIEF DESCRIPTION OF THE DRAWINGS

The invention will now be explained by way of example with reference to preferred exemplary embodiments and with respect to the accompanying drawings, in which:

FIG. 1 shows a schematic block diagram of a transceiver unit which can be used in a vehicle;

FIG. 2 shows a schematic block diagram of an antitheft system according to the invention; and

FIG. 3 shows a diagram explaining the determination of distance by means of FMCW radar technology.

In the following description of the drawings, identical reference symbols designate identical or comparable components.

### DETAILED DESCRIPTION OF THE PREFERRED EMBODIMENTS

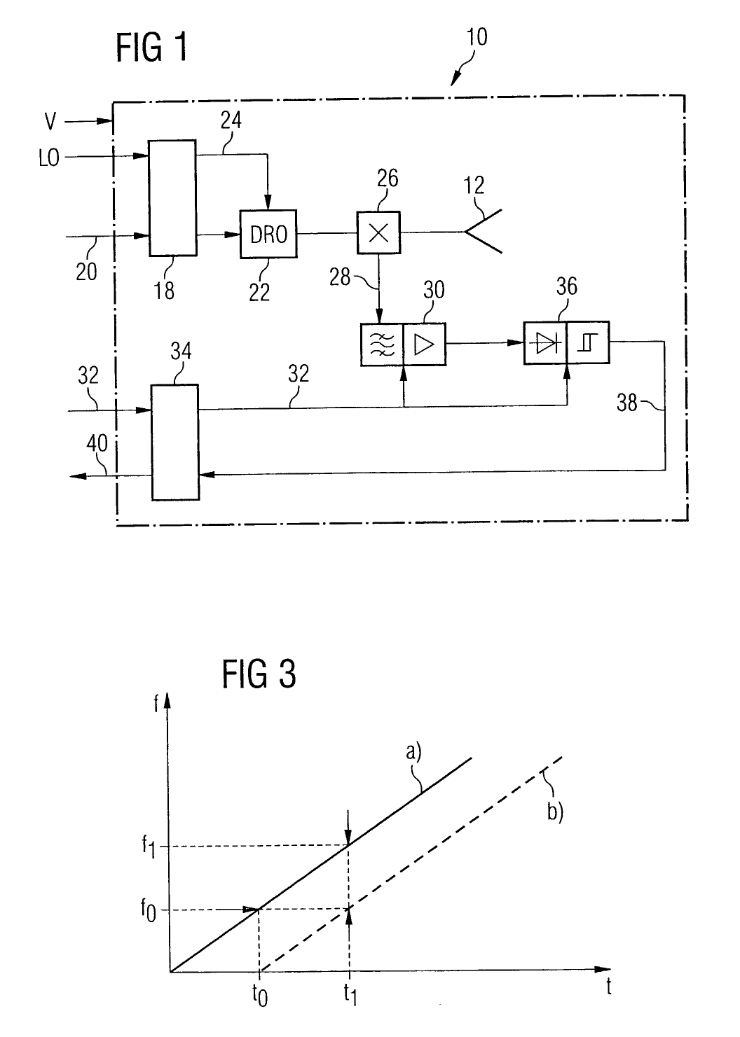

FIG. 1 shows a schematic block diagram of a transceiver unit 10 which can be used in a vehicle. The transceiver unit 10 is supplied with a voltage V of, for example, 5 V. A local oscillator frequency (LO) of, for example, 24 GHz is input into a first driver 18. The driver 18 also receives data 20 which is to be transmitted by the transceiver unit 10. The driver 18 makes available an enable or disable signal 24 for a dielectric resonance oscillator 22 (DRO). The data to be transmitted is also input into the dielectric resonance oscillator 22. The signal which is generated by the dielectric resonance oscillator 22 is fed to an antenna 12 via a mixer 26. The signal is transmitted by this antenna 12. The antenna 12 also operates as a reception antenna so that a code transmitter (not illustrated in FIG. 1) receives reflected signals which are generally modulated. The antenna of the transceiver unit 10 and/or the antenna of the code transmitter are inventively configured as directional antennas here. The signals received by the antenna 12 are mixed in a mixer 26 with the output signals of the dielectric resonance oscillator 22, an intermediate frequency signal 28 being generated. This intermediate frequency signal 28 is fed to an intermediate frequency filter/amplifier unit 30. The output signal of the intermediate frequency filter/amplifier unit 30 is passed on, as a function of an enable or disable signal 32, by a second driver 34 to a demodulator 36 which also makes available demodulated data 38 as a function of the enable/disable signal. The demodulated data 38 is fed, via the second driver 34, to further evaluation means 40, for example an analog/digital converter for further digital processing of the signals.

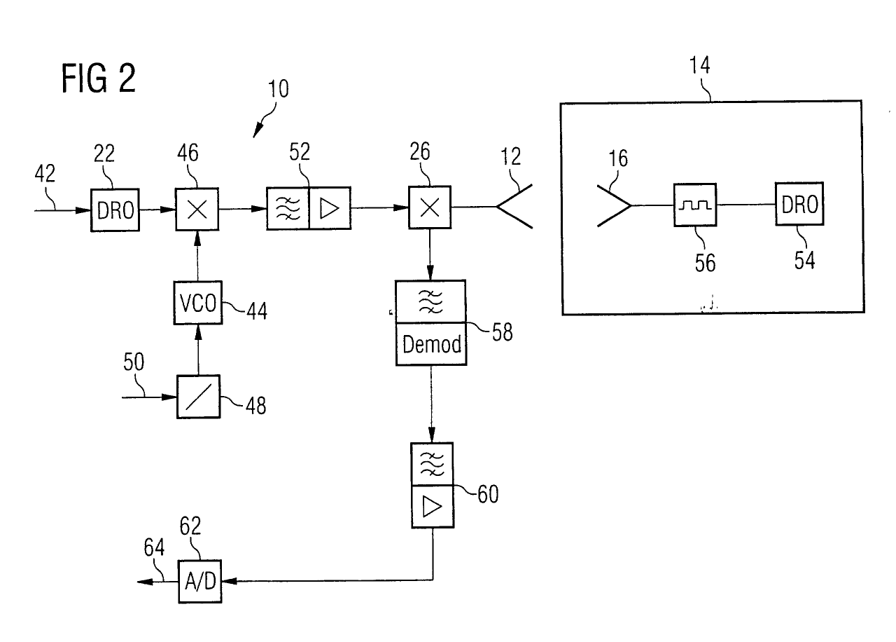

FIG. 2 shows a schematic block diagram of an antitheft system according to the invention. An enable/disable signal 42 is fed to a dielectric resonance oscillator 22. The output signal of the dielectric resonance oscillator 22 is mixed with the output signal of a voltage-controlled oscillator 44 in a mixer 46. As the output frequency of the voltage-controlled oscillator 44 is tuned by a ramp generator 48 which is controlled by a trigger signal 50, a signal with a variable frequency is present at the output of the mixer 46. This signal with a variable frequency is fed to a filter/amplifier unit 52 and passed on to an antenna 12 via a mixer 26. The signal is output by the antenna 12. When a code transmitter 14 is present, the signal which is transmitted by the antenna 12 is received by the antenna 16 of the code transmitter 14 and modulated there by means of the frequency signal of a dielectric resonance oscillator 54. The signal is broadcast again by means of a back scatter unit 56 via the antenna 16 which also acts as a transmission antenna so that said signal can be received by the antenna 12, also acting as a reception antenna, of the transceiver unit 10 which is connected to the vehicle. The signal is mixed in the mixer 26 with the signal with a variable frequency, from the filter/amplifier unit 52. The mixing result is further processed in a filter/demodulator unit 58 and forwarded to a filter/amplifier unit 60. The signal is fed from this filter/amplifier unit 60 to an analog/digital converter 62 so that digital evaluation of the signals can subsequently be performed by evaluation means 64.

Owing to the transit time of the signals between the antennas 12, 16 involved, the signal which is received by the antenna 12 has a different frequency from the signal which is fed at the time of reception to the mixer 26 by the filter/amplifier unit 52. As the output signal of the mixer 26 depends on the difference in frequencies between the two signals, the mixing result is a measure of the transit time of the signals between the antennas 12, 16, and thus of the distance between the vehicle and code transmitter 14. The described FMCW radar method thus makes available a measure of the distance between the vehicle and code transmitter. Furthermore, after evaluation of the signals, it is possible to use the distance between the vehicle and code transmitter 14 as a criterion for the activation of the lock system. Furthermore, as at least one of the antennas 12, 14 involved is a directional antenna, not only the distance criterion but also the direction criterion is used as the decisive factor for the question of the activation of the lock system.

FIG. 3 shows a diagram explaining the FMCW radar method. In the diagram, the frequency f is plotted against the time t. The continuous line a shows a first frequency profile. The dashed line b shows a second frequency profile. If a signal with the frequency f₀ is broadcast at a time t₀, this signal is received again at a later time t₁ with an unchanged frequency f₀. However, at this time, a signal with a variable frequency f₁ is already present at a mixer so that the signals are mixed with the frequencies f₀ and f₁. As the transit time t₁-t₀ influences the difference in frequencies f₁-f₀ and this determines the mixing result, the mixing result is a measure of the transit time t₁-t₀, and thus of the distance between the vehicle and code transmitter.

The features of the invention which are disclosed in the description above, in the drawings and in the claims can be essential, either individually or else in any desired combination, for the implementation of the invention.

1. An antitheft system for a vehicle having
at least one radio frequency receiver unit which is connected to the vehicle and has at least one first antenna,
at least one code transmitter having at least one radio frequency transmitter unit which has at least one second antenna, and
means for evaluating signals which are received by the at least one receiver unit, wherein at least the first antenna or the second antenna is a directional antenna.

2. The antitheft system as claimed in claim 1, wherein
the radio frequency receiver unit which is connected to the vehicle is contained in a transceiver unit, the first antenna operating as a transmission antenna and reception antenna, and
the radio frequency transmitter unit which is provided in the code transmitter is contained in a transceiver unit, the second antenna operating as a transmission antenna and reception antenna.

3. The antitheft device as claimed in claim 1, wherein
the second antenna which is assigned to the code transmitter is provided for receiving signals which are transmitted by the transceiver unit of the vehicle,
the code transmitter has means for modulating the received signals, and
the second antenna which is assigned to the code transmitter is provided for transmitting the modulated signals.

4. The antitheft system as claimed in claim 1, wherein the range of the radio frequency signals is limited.

5. The antitheft system as claimed in claim 1, wherein the evaluation means determine a variable as a measure of the distance between the vehicle and the code transmitter.

6. The antitheft system as claimed in claim 1, wherein the evaluation means determine a variable as a measure of the distance between the vehicle and the code transmitter by means of back scatter radar technology.

7. The antitheft system as claimed in claim 1, wherein the system operates in the GHz range.

8. A method for operating an antitheft system for a vehicle, in which
at least one radio frequency receiver unit which is connected to the vehicle receives radio frequency signals via a first antenna,
at least one code transmitter having at least one radio frequency transmitter unit transmits radio frequency signals via at least one second antenna, and
the at least one receiver unit evaluates received signals, wherein at least the first antenna or the second antenna is a directional antenna.

9. The method as claimed in claim 8, wherein
the first antenna is used as a transmission antenna and reception antenna of a transceiver unit which is connected to the vehicle, and
the second antenna is used as a transmission antenna and reception antenna of a transceiver unit which is provided in the code transmitter.

10. The method as claimed in claim 8, wherein
the first antenna which is assigned to the vehicle transmits radio frequency signals,
the second antenna which is assigned to the code transmitter receives the signals which are transmitted by the first antenna,
the signals which are received by the second antenna are modulated in the code transmitter,
the second antenna transmits the modulated signals,
the first antenna receives the transmitted modulated signals, and
the modulated signals received by the first antenna are evaluated.

11. The method as claimed in claim 8, wherein the range of the radio frequency signals is limited.

12. The method as claimed in claim 8, wherein during the evaluation of the signals received by the receiver unit of the vehicle, a variable is determined as a measure of the distance between the vehicle and the code transmitter.

13. The method as claimed in claim 8, wherein during the evaluation of the signals received by the receiver unit of the vehicle, a variable is determined as a measure of the distance between the vehicle and the code transmitter by means of back scatter radar technology.

14. The method as claimed in claim 8, wherein the system operates in the GHz range.

15. Radio frequency receiver unit for use in an antitheft system for a vehicle comprising:
a driver for receiving data to be transmitted;
a transmitter unit coupled with the driver for modulating the data;
an antenna coupled with the transmitter unit, wherein the antenna is a directional antenna and wherein the radio frequency receiver is connected to the vehicle.

16. Radio frequency receiver as in claim 15, wherein the radio frequency receiver is contained in a transceiver unit.

17. Radio frequency receiver as in claim 15, wherein the transmitter unit comprises a dielectric resonance oscillator coupled with the driver, a mixer coupled with the dielectric resonance oscillator and an intermediate frequency filter/amplifier generating an output signal fed to the antenna.

18. A code transmitter for use in an antitheft system for a vehicle comprising:
a directional antenna for receiving and transmitting of antitheft system data;
a back scatter unit coupled with the directional antenna; and
a dielectric resonance oscillator coupled with the back scatter unit.
